(19) United States
(12) Patent Application Publication
(10) Pub. No.: US 2001/0047925 A1
(43) Pub. Date: Dec. 6, 2001

(54) DEVICE AND METHOD FOR CONVEYING MATERIALS

(75) Inventor: JAMES F. SULLIVAN JR, GARLAND, TX (US)

Correspondence Address: SIDLEY & AUSTIN, 717 N HARWOOD SUITE 3400, DALLAS, TX, 752016507

(73) Assignee: Triple/S Dynamics, Inc.

(21) Appl. No.: 09/309,736

(22) Filed: May 11, 1999

(51) Int. Cl. B65G 25/04

(52) U.S. Cl. 198/750.8; 74/52

(57) ABSTRACT

A conveyor for materials uses a gearset to generate horizontal differential conveying motion in a conveying member. The conveying motion includes an advancing stroke in a conveying direction and a retracting stroke in a direction opposite to the conveying direction. The linear velocity of the retracting stroke is greater than the linear velocity of the advancing stroke to move materials along the conveying member in the conveying direction. The gearset is preferably a ring gear and a pinion.

### FIELD OF THE INVENTION

This invention is directed generally to a conveyor for materials. In one aspect, the invention relates to a device and method for generating a horizontal differential motion for conveying materials. In another aspect, the invention relates to a horizontal differential motion conveyor in which a gearset is used to generate a conveying motion. In yet another aspect, the invention relates to a horizontal differential motion conveyor in which a ring gear and a pinion are used to generate a conveying motion. In a further aspect, the invention relates to a horizontal differential motion conveyor having a conveying motion which has an advancing stroke and a retracting stroke, wherein a linear velocity of the retracting stroke is greater than a linear velocity of the advancing stroke. In yet a further aspect, the invention relates to horizontal differential motion conveyor having a conveying motion which can be described by an approximation of a sawtooth waveform.

### BACKGROUND OF THE INVENTION

Many production processes require the products being processed to be conveyed from one place to another place. Some products, such as dry cereals, snack chips, and the like, are very fragile and must be handled carefully. Belt conveyors are not well suited to this environment because they are difficult to clean. Vibratory conveyors oscillate at an acute angle to the conveying direction in order to convey the product. These conveyors bounce the product as it is conveyed, which causes the product to break and a residue to build up on the conveying surface.

To overcome these problems, conveyors have been developed which use a horizontal differential motion to propel the product along a conveying surface. Horizontal differential motion is the resultant of the superposition of two sinusoidal waveforms which result in a second order approximation of a sawtooth waveform. A sawtooth waveform 100, overlaid with a typical horizontal differential motion waveform 102, is shown in FIG. 1. The horizontal differential motion waveform can be expressed as a Fourier series having two harmonics by the expression:

ƒ(θ₁,θ₂)=2 sin(θ₁)−sin(2θ₂)

wherein:

θ₁=phase angle of the first harmonic waveform; and

θ₂=phase angle of the second harmonic waveform.

Descriptively, the above equation provides that the primary harmonic function has two times the amplitude of the secondary harmonic function, while the secondary harmonic function is at twice the frequency of the primary harmonic function. Further, the secondary harmonic function is moving in the opposite direction from the primary harmonic function.

The resulting motion is made up of a series of oscillations, parallel to the conveying direction, which propels a product without causing the product to bounce on the conveying surface. The oscillations are made up of a slower advancing stroke and a faster retracting stroke. The slower advancing stroke moves in the conveying direction and carries the product with it. The faster retracting stroke causes the product to slide across and advance along the conveying surface by overcoming the friction between the product and the conveying surface. Repeating this motion causes the product to be conveyed, in the conveying direction, along the conveying surface. The conveying speed for this type of conveyor is increased by increasing either the amplitude or the frequency of the horizontal differential motion.

Most horizontal differential motion conveyors typically use two sets of two rotating, eccentrically-weighted shafts to produce the desired motion. The shafts in each set rotate in opposite directions to counteract any vertical force component. This arrangement results in a horizontal resolution of the two force functions, which are each simple harmonics, but combine to produce a second order approximation of a sawtooth function. Examples of horizontal differential motion conveyors which use counter-rotating weighted shafts can be found in U.S. Pat. Nos. 5,392,898 and 5,584,375 to Burgess et al. A further example of this type of horizontal differential motion conveyor is the Slipstick® conveyor, which is manufactured by Triple/S Dynamics, Inc. of Dallas, Tex.

As stated above, one way to improve the conveying speed is to increase the oscillation amplitude. In a counter-rotating shaft conveyor, increases in oscillation amplitude require large increases in the mass of the eccentric weights used to generate the differential force, since the stroke of this type of conveyor is proportional to the mass of the eccentric weights. The mass used to generate the horizontal differential motion must also be oscillated, thus the efficiency of the conveyor is diminished due to the added drive mass. Accordingly, the excursion or linear displacement of the conveyor is limited, from a practical standpoint, to one inch or less. Further, larger housings are required when the mass of the eccentric weights is increased. Another method for increasing the conveying speed is to increase the oscillation frequency. Increases in the oscillation frequency, however, cause increases in the forces which are resisted by the conveyor supports. For these reasons, counter-rotating shaft conveyors do not lend themselves to miniaturization.

Other drive unit configurations have been employed to produce a horizontal differential conveying motion. A drive unit using cams and cam followers is disclosed in U.S. Pat. No. 5,046,602 to Smalley et al. This design is inherently complex, and wear on the contacting surfaces results in a comparatively high level of required maintenance. In addition, a drive unit employing a bent universal joint is disclosed in U.S. Pat. Nos. 5,351,807 and 5,699,897 to Svejkovsky. This configuration results in a rather large load being passed through the small bearings in the universal joint. Reversals of the load on the drive train can also cause damage to the universal joint. Further, a significant amount of space is required to house the shaft, bearings, gear reducer, and other elements of the drive.

Thus, a need exists for a horizontal differential motion conveyor having a drive unit which can be made compact and thereby lends itself to miniaturization. Further, a need exists for a horizontal differential motion conveyor having a drive unit which can produce large amplitudes, and thus, greater conveying speeds. Yet another need exists for a horizontal differential motion conveyor having a drive unit which is simple and requires little maintenance. Yet a further need exists for a horizontal differential motion conveyor having a drive unit which is tolerant of load reversals on the drive unit.

### BRIEF SUMMARY OF THE INVENTION

The present invention is a new and advantageous device and method for generating a horizontal differential motion for conveying materials. The device generates a horizontal differential conveying motion substantially only in a direction parallel to a conveying direction. The conveyor of the present invention can be made compact and, thus, lends itself to miniaturization. The drive unit of the present invention can generate large amplitudes, thereby producing greater conveying speeds. The drive unit of the present invention is simple, requires little maintenance, and is tolerant of load reversals.

According to one aspect of the present invention, a device for generating a horizontal differential motion includes a first connection for attaching the device to a second device, such as a conveying member. The first connection is rotatable about a first axis of rotation. Further, the first axis of rotation is rotatable about a second axis of rotation. By rotating the first connection about the first axis of rotation while rotating the first axis of rotation about the second axis of rotation, a horizontal differential motion is produced.

According to another aspect of the present invention, a method of generating a horizontal differential conveying motion includes the steps of rotating the first connection about the first axis of rotation while rotating the first axis of rotation about the second axis of rotation. The motion generated by these steps is transmitted to a second device, such as a conveying member, from a location corresponding to the first connection.

According to yet another aspect of the present invention, a conveyor is provided having a drive unit, comprising a gearset, which generates a conveying motion substantially only in a conveying direction. The conveying motion has an advancing stroke in the conveying direction and a retracting stroke in a direction opposite to the conveying direction. The linear velocity of the retracting stroke is larger than that of the advancing stroke so as to move material being conveyed along a conveying member in the conveying direction.

Further, according to another aspect of the present invention, the conveying member is elongated in shape and has a longitudinal axis which is substantially parallel to the conveying direction.

According to yet a further aspect of the present invention, the gearset of the drive unit includes a ring gear and a pinion.

According to another aspect of the present invention, a plot of the conveying motion with respect to time is an approximation of a sawtooth waveform.

According to yet another aspect of the present invention, a conveyor is provided having a power source which rotates a pinion engaged with a ring gear. A conveyor linkage is attached to a face of the pinion and to a conveying member. As the power source rotates the pinion, a conveying motion is generated having an advancing stroke in a conveying direction and a retracting stroke in a direction opposite to the conveying direction. The linear velocity of the retracting stroke is larger than that of the advancing stroke so as to move material being conveyed along a conveying member in the conveying direction.

According to a further aspect of the present invention, a pitch radius of the ring gear is approximately equal to three times a pitch radius of the pinion.

According to yet a further aspect of the present invention, a distance between a first axis of the pinion and an second axis of the ring gear is approximately two times a distance between the location where the conveyor linkage is attached to the face of the pinion and the first axis of the pinion.

According to still a further aspect of the invention, the conveying motion can be described by the function:

ƒ(t)=2 sin(ω₁t)−sin(2ω₂t)

wherein:

ω₁=an angular velocity of the first axis of the pinion about the second axis of the ring gear; and

ω₂=an angular velocity of a first connection of the conveyor linkage on the face of the pinion about the first axis of the pinion.

### BRIEF DESCRIPTION OF THE SEVERAL VIEWS OF THE DRAWINGS

Other advantages and features of the invention will become more apparent with reference to the following detailed description of the presently preferred embodiment thereof in connection with the accompanying drawings, wherein like reference numerals have been applied to like elements, in which:

FIG. 1 is a graph illustrating a sawtooth waveform and an approximation of a sawtooth waveform;

FIG. 2 is a plan view of a drive unit and a conveyor of the present invention;

FIG. 3 is a schematic view of a drive unit of the present invention;

FIG. 4 is a plan view of a drive unit of the present invention;

FIG. 5 is a schematic view of the drive unit of FIG. 4 and a corresponding plot of a horizontal differential motion produced by the drive unit.

FIG. 6 is a graph showing relationships between table movement or displacement and the distance between the first connection and the first axis;

FIG. 7 is a plot showing the locations of the pinion and the first connection according to one embodiment of the present invention wherein the distance between the first connection and the first axis is 25.4 mm (1.0 inches);

FIG. 8 is a plot showing the locations of the pinion and the first connection according to another embodiment of the present invention wherein the distance between the first connection and the first axis is 15.7 mm (0.6 inches);

FIG. 9A is a schematic view of one embodiment of conveyor of the present invention;

FIG. 9B is a graph showing a waveform corresponding to the embodiment of FIG. 9A;

FIG. 10A is a schematic view of another embodiment of the present invention;

FIG. 10B is a graph showing a waveform corresponding to the embodiment of FIG. 10A;

FIG. 11A is a schematic view of yet another embodiment of the present invention;

FIG. 11B is a graph showing a waveform corresponding to the embodiment of FIG. 11A;

FIG. 12A is a schematic view of a further embodiment of the present invention; and

FIG. 12B is a graph showing a waveform corresponding to the embodiment of FIG. 12A.

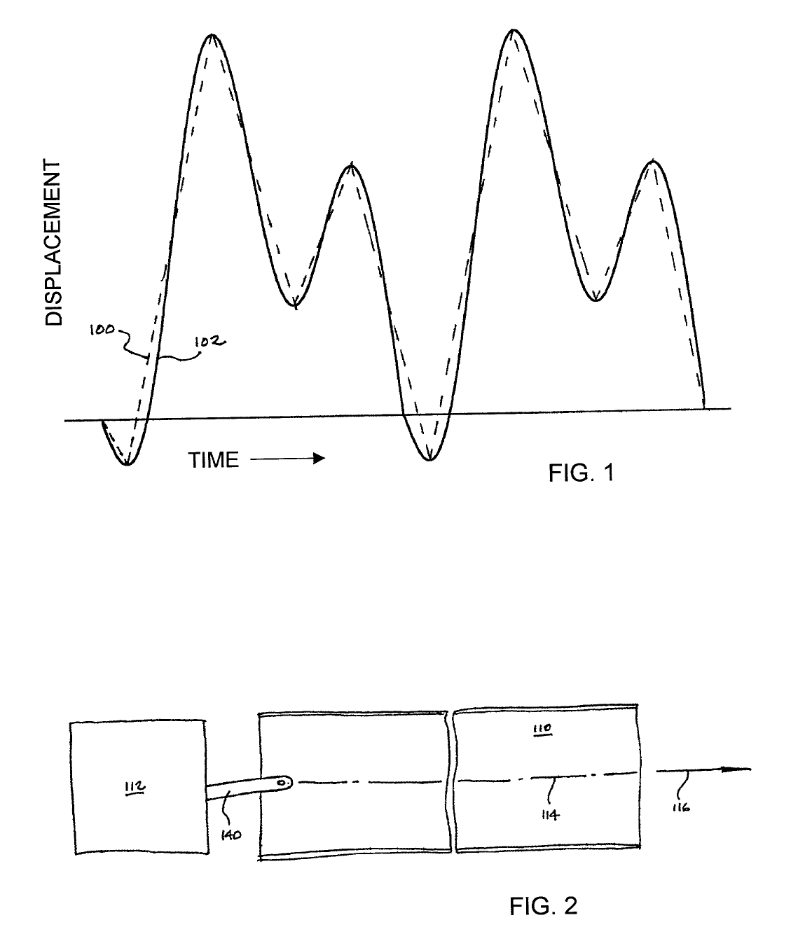

### DETAILED DESCRIPTION OF THE INVENTION

Referring to the drawings, and FIG. 2 in particular, shown therein is a conveyor of the present invention having a conveying member 110 and a drive unit 112. The conveying member 110 can be configured in a variety of shapes but is preferably elongated with a longitudinal axis 114 which is substantially parallel to a conveying direction 116.

The drive unit 112 of the present invention generates the conveying motion substantially only in a conveying direction 116 so as to move materials along the conveying member 110 in the conveying direction 116. An alternate conveying direction can be a direction opposed to the conveying direction 116.

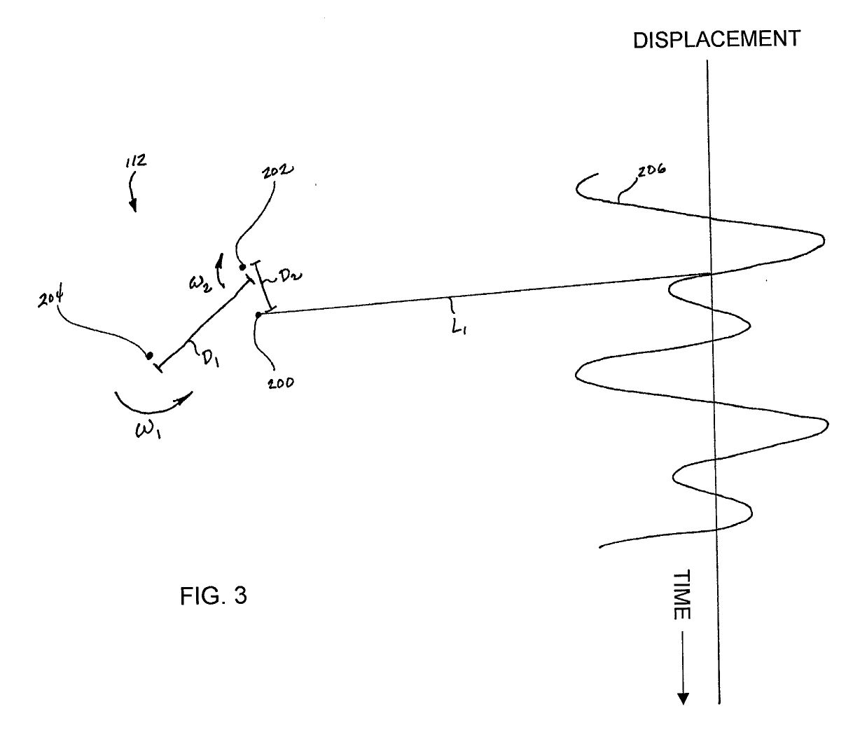

Referring now to FIG. 3, the drive unit 112 of the present invention is comprised of a first connection 200, a first axis 202, and a second axis 204. The first axis 202 and the second axis 204 are generally perpendicular to the view shown by FIG. 3. A horizontal differential motion is achieved by rotating the first connection 200 about the first axis 202 in a first direction at an angular velocity ω₂ while rotating the first axis 202 about the second axis 204 in a second direction, counter to that of the first direction, at an angular velocity ω₁. The line L₁ represents a linkage from the first connection 200 to an exemplary outputted horizontal differential motion waveform 206. The first axis 202 is located a distance D₁ away from the second axis 204, and the first connection 200 is located a distance D₂ away from the first axis 202. In a preferred embodiment, the distance D₁ from the second axis 204 to the first axis 202, in a plane perpendicular to both the first axis 202 and the second axis 204, is approximately two times the distance D₂ from the first connection 200 to the first axis 202. The resulting horizontal differential motion can be described as a Fourier series by the function:

ƒ(t)=2 sin(ω₁t)−sin(2ω₂t)

wherein:

t=time;

ω₁=an angular velocity of the first axis 202 about the second axis 204; and

ω₂=an angular velocity of the first connection 200 about the first axis 202.

Descriptively, the above function defines a waveform which has two harmonic components. The first component (2 sin(ω₁t)) has twice the amplitude of the second component (sin(2ω₂t)), while the second component has twice the frequency of the first component. Further, the second component is moving in the opposite direction from the first component.

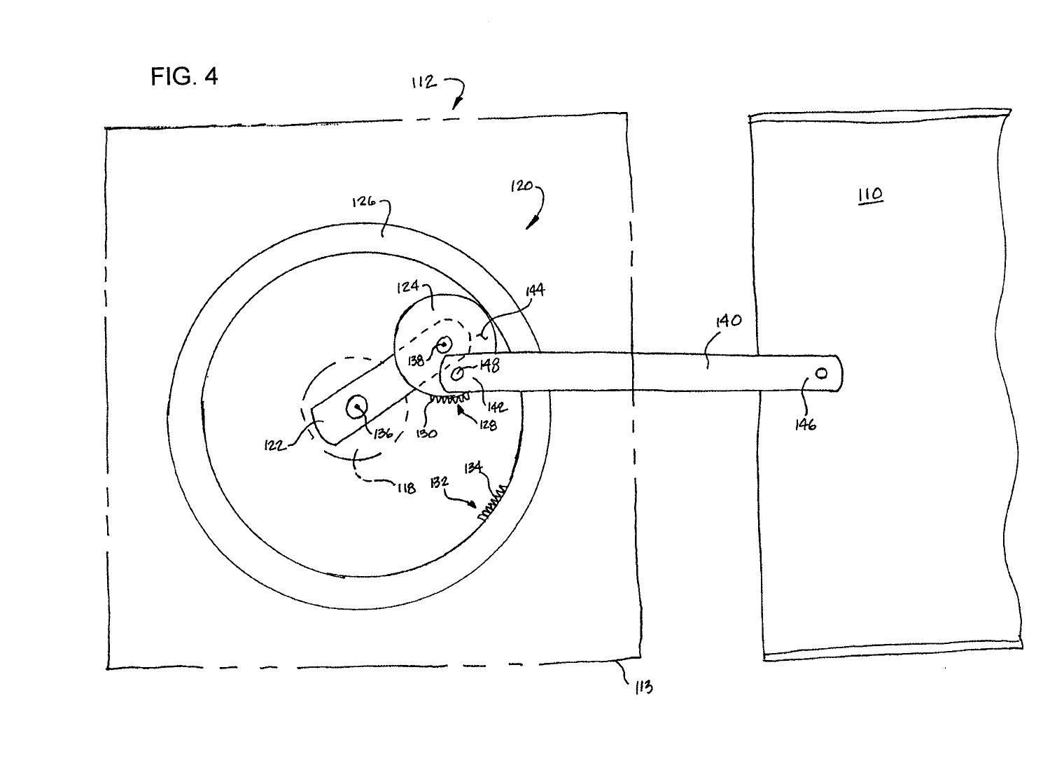

FIG. 4 shows a preferred embodiment of the present invention, wherein the drive unit housing 113 is shown in phantom. The drive unit 112 includes a power source 118, such as an electric motor (shown in phantom); a gearset 120; and a motor linkage 122. The gearset 116 comprises a pinion 124 engaged with a ring gear 126. The pinion 124 has an outer surface 128 with a plurality of teeth 130. Similarly, the ring gear 126 has an inner surface 132 with a plurality of teeth 134. At any given time, a subset of the plurality of pinion teeth 130 engages a subset of the plurality of ring gear teeth 134.

The power source 118 is connected to the pinion 124 by a motor linkage 122 so as to cause the pinion 124 to rotate about a second axis 136 as the pinion 124 rotates about a first axis 138. The first axis 138 and the second axis 136 correspond to the first axis 202 and the second axis 204, respectively, of FIG. 3. The second axis 136 is collinear with a center axis of the ring gear 126, and the first axis 138 is collinear with a center axis of the pinion 124. A conveyor linkage 140 is connected at a first end 142 to a face 144 of the pinion 124 at a fixed distance away from the first axis 138. The first connection 148 between the first end 142 of the conveyor linkage 140 and the face 144 of the pinion 124 allows the conveyor linkage 140 to rotate in a plane perpendicular to the first axis 138 and the second axis 136. The first connection 148 corresponds to the first connection 200 of FIG. 3. A second end 146 of the conveyor linkage 140 is attached by a second connection 149 to the conveying member 110 so as to also allow the conveyor linkage 140 to rotate in a plane perpendicular to the first axis 138 and the second axis 136.

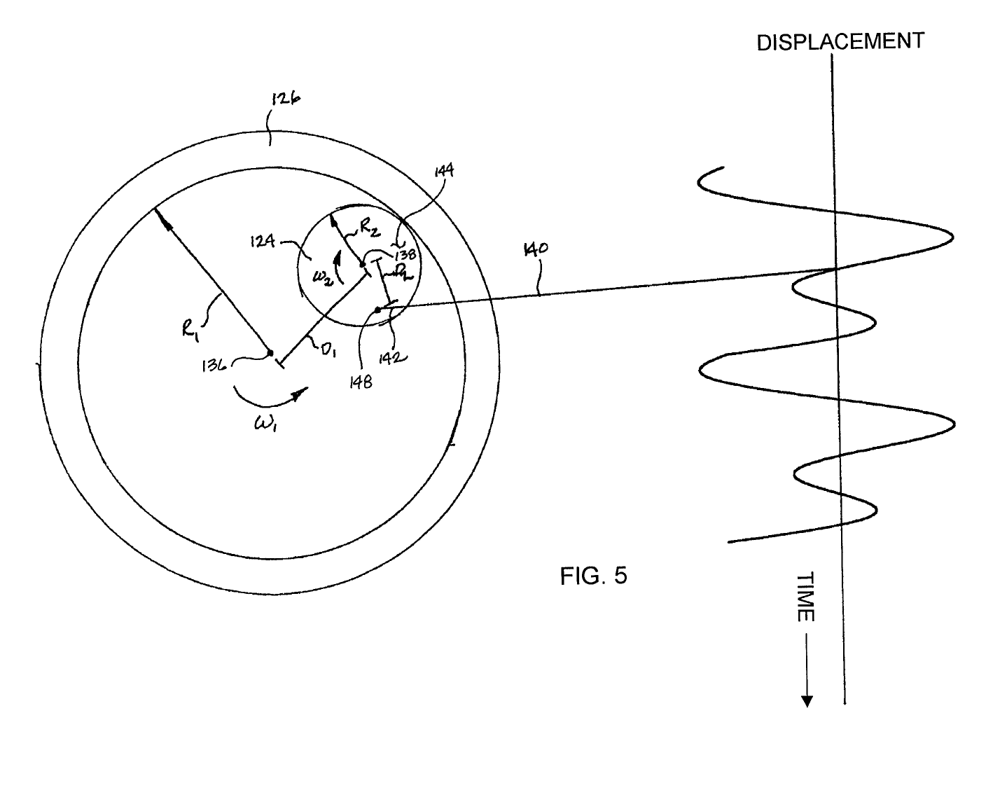

Referring now to FIG. 5, the ring gear 126, the pinion 124, and the conveyor linkage 140 are shown in schematic form. In a preferred embodiment of the present invention, the pitch radius R₁ of the ring gear 126 is approximately three times the pitch radius R₂ of the pinion 124. Further, the distance D₁ from the first axis 138 to the second axis 136, in a plane perpendicular to the first axis 138 and the second axis 136, is approximately two times the distance D₂ from the first connection 148 at the first end 142 of the conveyor linkage 140 on the face 144 of the pinion 124 to the first axis 138. As the power source 118 (shown in FIG. 4) causes the pinion 124 to rotate clockwise about the first axis 138 and to rotate counterclockwise about the second axis 136, a horizontal differential motion is produced at the first connection 148. A plot of this horizontal differential motion, which is an approximation of a sawtooth waveform, is shown in FIG. 5. This motion can be described as a Fourier series by the formula:

ƒ(t)=2 sin(ω₁t)−sin(2ω₂t)

wherein:

t=time;

ω₁=an angular velocity of the first axis 138 about the second axis 136; and

ω₂=an angular velocity of a connection 148 at the first end 142 of the conveyor linkage 140 on the face 144 of the pinion 124 about the first axis 138 of the pinion 124.

Descriptively, the above formula defines a waveform which has two harmonic components. The first component (2 sin(ω₁t)) has twice the amplitude of the second component (sin(2ω₂t)), while the second component has twice the frequency of the first component. Further, the second component is moving in the opposite direction from the first component.

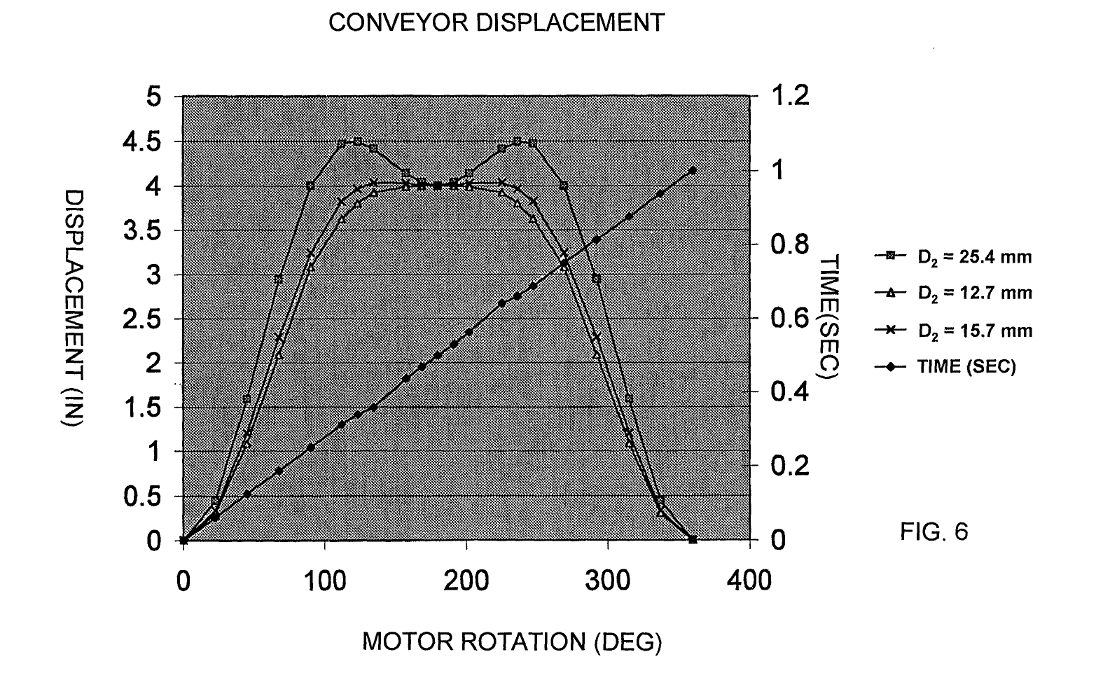

FIG. 6 illustrates a correlation between the distance D₂ and the movement or excursion of the conveying member 110 resulting from the horizontal differential motion generated by the drive unit 112 for one embodiment of the present invention. As the distance D₂ is varied from 15.7 mm (0.6 inches) to 25.4 mm (1.0 inch), the excursion increases from about 101.6 mm (4.0 inches) to about 114.3 mm (4.5 inches), and the overall shape of the motion curve changes to one having two distinct peaks. The formation of these peaks indicates that the horizontal differential motion reverses briefly during the overall cycle, which can improve the conveying characteristics of the device.

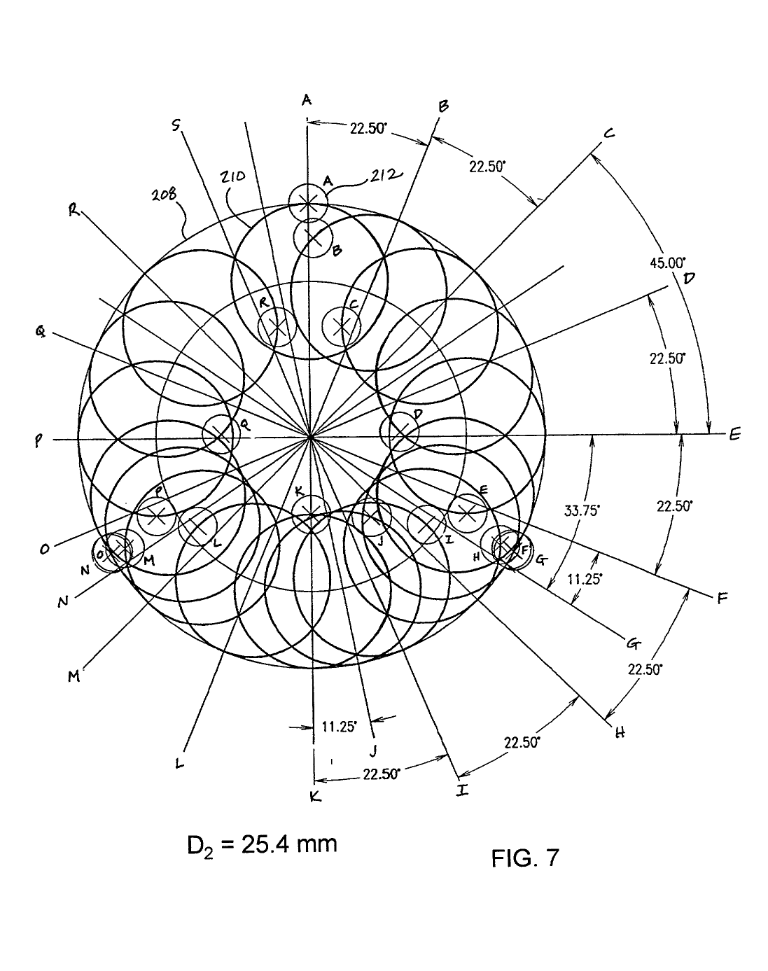

Referring now to FIG. 7, wherein the locations of the first connection 148 through one rotational cycle of one embodiment of the present invention are shown. The distance D₂ from the first connection 148 to the first axis 138 is 25.4 mm (0.6 inches). The circle 208 corresponds to the inner surface 132 of the ring gear 126. Each of the circles 210 (only one circle 210 is indicated in FIG. 7) corresponds to the outer surface 128 of the pinion 124 as the first axis 138 rotates about the second axis 136 at intervals A-S of one revolution of the power source 118. Each of the circles 212 (only one circle 212 is indicated in FIG. 7) corresponds to locations of the first connection 148 as the first connection 148 rotates about the first axis 138, also at intervals A-S, during one revolution of the power source 118.

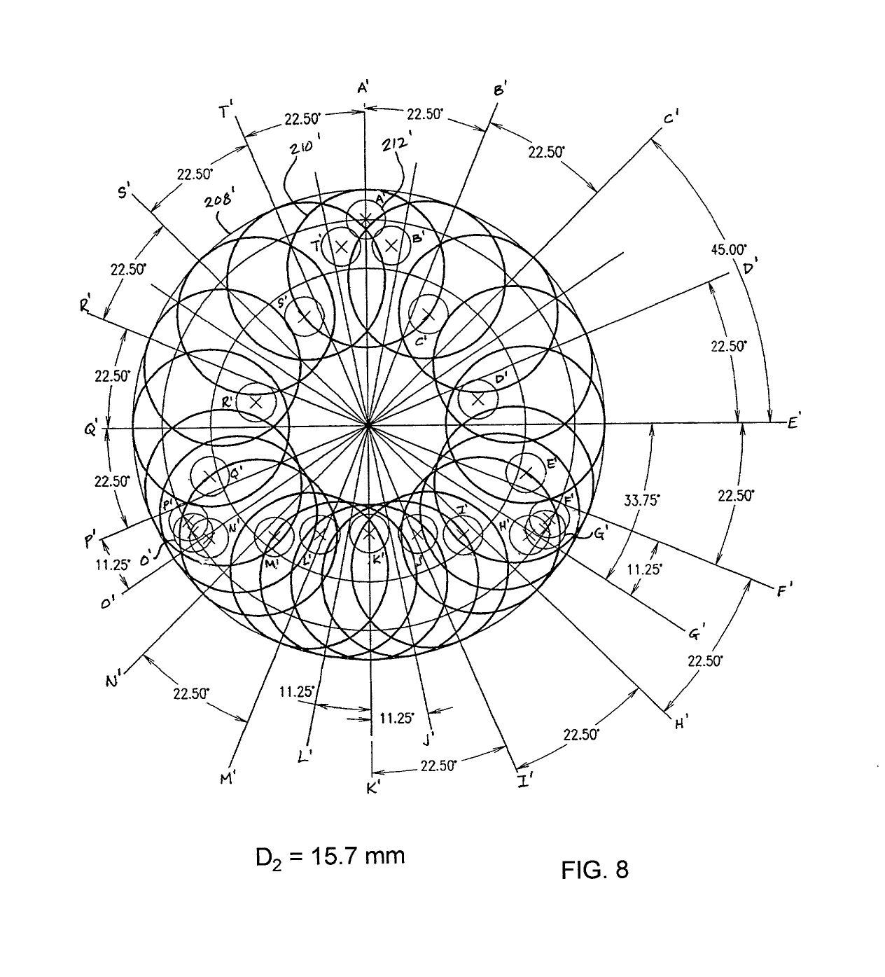

Similarly, in reference to FIG. 8, the locations of the first connection 148 through one rotational cycle of another embodiment of the present invention are shown. In this embodiment, distance D2, from the first connection 148 to the first axis 138, is 15.7 mm (0.6 inches). The circle 208′ corresponds to the inner surface 132 of the ring gear 126. Each of the circles 210′ (only one circle 210′ is indicated in FIG. 8) corresponds to the outer surface 128 of the pinion 124 as the first axis 138 rotates about the second axis 136 at intervals A′-T′ of one revolution of the power source 118. Each of the circles 212′ (only one circle 212′ is indicated in FIG. 8) corresponds to locations of the first connection 148 as the first connection 148 rotates about the first axis 138, also at intervals A′-T′, during one revolution of the power source 118.

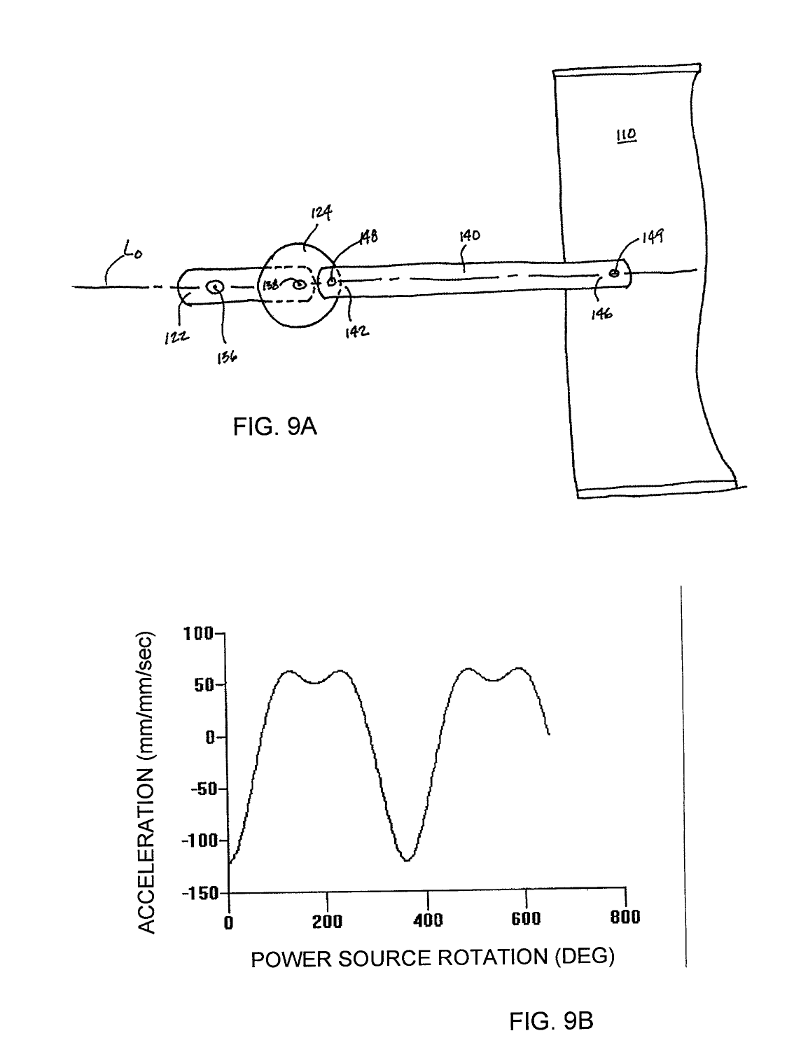

Acceleration generated by the device of the present invention is affected by the angular position of the first connection 148 with respect to the first axis 138, the second axis 136, and the second connection 149. Referring now to FIG. 9A, the device of the present invention is shown wherein the second axis 136, the first axis 138, the first connection 148, and the second connection 149 are all positioned on a line L₀ at the start of the motion cycle. FIG. 9B shows the acceleration at the second connection 149 with respect to the rotation of the power source 118 (e.g., motor) in degrees. The acceleration peaks, declines to a lower acceleration, and peaks again, wherein the values corresponding to each of the acceleration peaks are generally equal.

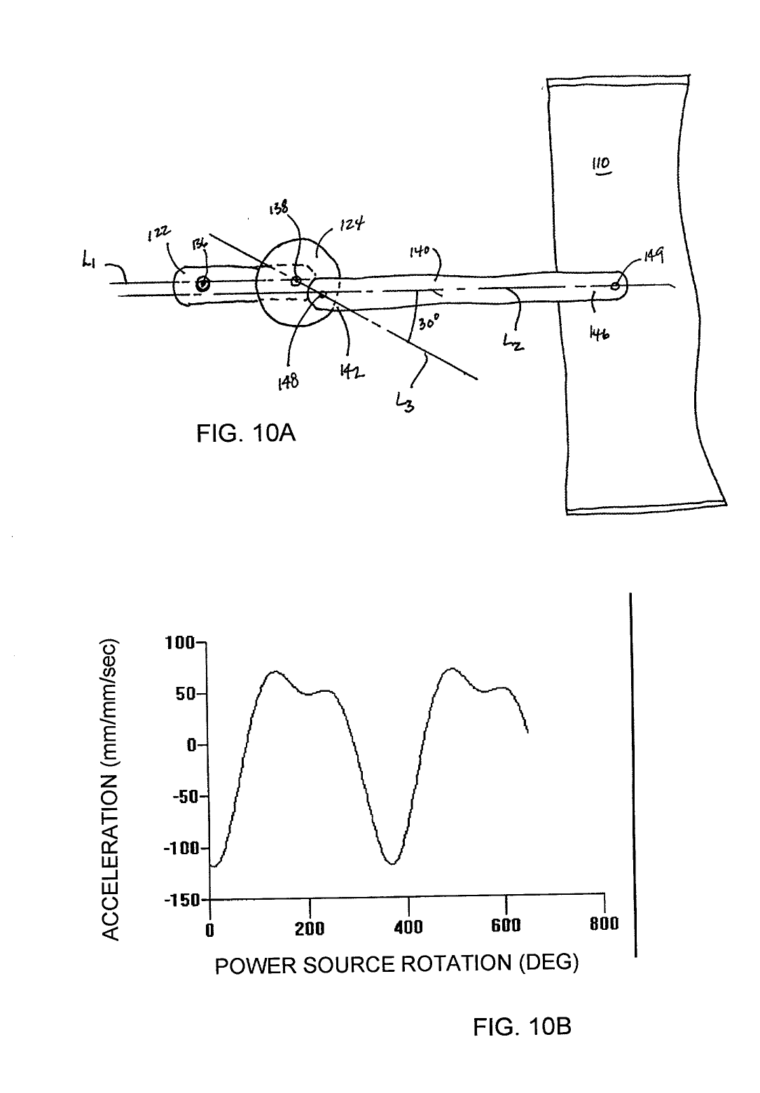

Referring now to FIG. 10A, the device of the present invention is shown wherein the first axis 138 and the second axis 136 fall on a line L₁ which is parallel to a line L₂ defined by the first connection 148 and the second connection 149. The first connection 148 is rotationally offset about the first axis 138 as compared to the arrangement shown in FIG. 9A. The first connection 148 is rotationally offset such that an angle between a line L₃, defined by the first axis 138 and the first connection 148, and the line L₂ is approximately 30°. This arrangement produces a horizontal differential motion which has an increased first acceleration peak and a decreased second acceleration peak within each cycle, as shown in FIG. 10B.

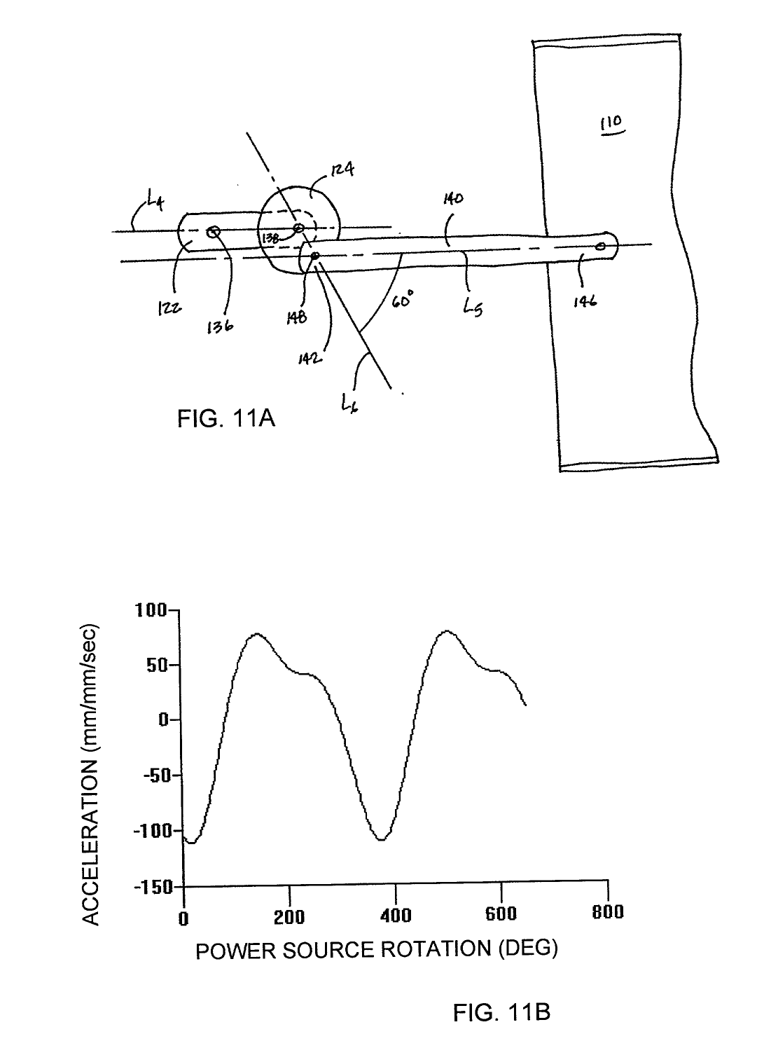

FIG. 11A depects a configuration which is similar to that of FIG. 10A, wherein lines L₄-L₆ generally correspond to lines L₁-L₃, respectively, of FIG. 10A. In this configuration, the angle between line L₅ and line L₆ is approximately 60°, which results in a horizontal differential motion having a further increase in the first acceleration peak and a decrease in the second acceleration peak, as shown in FIG. 11B.

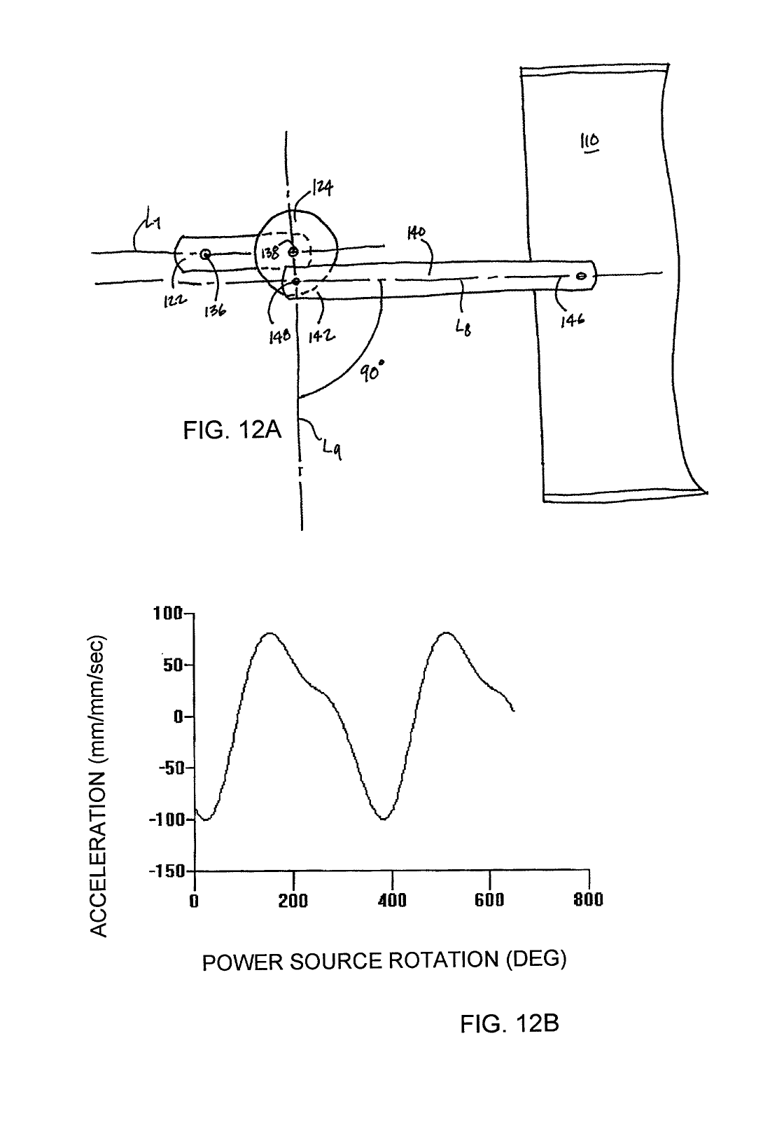

This progression is continued, as shown in FIG. 12A, wherein lines L₇-L₉ generally correspond to lines L₁-L₃ in FIG. 10A and lines L₄-L₉ in FIG. 11A, respectively. The angle between line L₈ and L₉ is approximately 90°, which further accentuates the first acceleration peak and reduces the second acceleration peak of the horizontal differential motion, as shown in FIG. 12B.

The conveyor of the present invention can be used in many conveying applications, for example, but not limited to, straight and curved path conveying, split flow conveying, singulating, de-shingling, and size control screening.

Although the present invention has been described with reference to a presently preferred embodiment, it will be appreciated by those skilled in the art that various modifications, alternatives, variations, etc., may be made without departing from the spirit and scope of the invention as defined in the appended claims.

What is claimed is:

1. A drive unit for generating a horizontal differential motion for a conveyor, comprising:
a first axis;
a second axis which is substantially parallel to said first axis, wherein said first axis is capable of being rotated about said second axis; and
a first connection for transmitting said horizontal differential motion to said conveyor, wherein said first connection is capable of being rotated about said first axis.

2. A drive unit, as claimed in claim 1, wherein a distance from said first axis to said second axis, in a plane substantially perpendicular to each of said first axis and said second axis, is approximately two times a distance from said first connection to said first axis, in a plane substantially perpendicular to said first axis and containing said first connection.

3. A drive unit, as claimed in claim 1, wherein said horizontal differential motion is described by the function:
ƒ(t)=2 sin(ω₁t)−sin(2ω₂t)
wherein:
t=time;
ω₁=an angular velocity of said first axis rotating about said second axis; and
ω₂=an angular velocity of said first connection rotating about said first axis.

4. A drive unit, as claimed in claim 1, wherein said first connection does not fall on a line which is perpendicular to said first axis and said second axis at a start of a horizontal differential motion cycle.

5. A drive unit for generating a horizontal differential motion for a conveyor, comprising:
a pinion having an outer surface with a plurality of teeth, a first axis which is collinear with an axis of rotation of said outer surface, and a face which lies in a plane perpendicular to said first axis;
a ring gear having an inner surface with a plurality of teeth, wherein a subset of said plurality of teeth of said outer surface of said pinion engages a subset of said plurality of teeth of said inner surface of said ring gear, and a second axis which is collinear with an axis of rotation of said inner surface;
a power source connected to said pinion for rotating said pinion about said first axis, thus causing said first axis to rotate about said second axis; and
a first connection disposed on said face of said pinion for transmitting said horizontal differential motion to said conveyor.

6. A drive unit, as claimed in claim 5, wherein a distance from said first axis to said second axis, in a plane substantially perpendicular to each of said first axis and said second axis, is approximately two times a distance from said first connection to said first axis, in a plane substantially perpendicular to said first axis and containing said first connection.

7. A drive unit, as claimed in claim 5, wherein said horizontal differential motion is described by the function:
ƒ(t)=2 sin(ω₁t)−sin(2ω₂t)
wherein:
t=time;
ω₁=an angular velocity of said first axis rotating about said second axis; and
ω₂=an angular velocity of said first connection rotating about said first axis.

8. A drive unit as claimed in claim 5, wherein a dimension of a pitch radius of said ring gear is approximately equal to three times a dimension of a pitch radius of said pinion.

9. A drive unit, as claimed in claim 5, wherein said first connection does not fall on a line which is perpendicular to said first axis and said second axis at a start of a horizontal differential motion cycle.

10. A conveyor, comprising:
a pinion having an outer surface with a plurality of teeth, a first axis which is collinear with an axis of rotation of said outer surface, and a face which lies in a plane perpendicular to said first axis;
a ring gear having an inner surface with a plurality of teeth, wherein a subset of said plurality of teeth of said outer surface of said pinion engages a subset of said plurality of teeth of said inner surface of said ring gear, and a second axis which is collinear with an axis of rotation of said inner surface;
a power source connected to said pinion for rotating said pinion about said first axis, thus causing said first axis to rotate about said second axis;
a conveying member for conveying materials;
a conveyor linkage having a first end and a second end; and
a first connection disposed on said face of said pinion and rotatably attached to said first end of said conveyor linkage for transmitting a horizontal differential motion from said first connection to said conveyor linkage,
wherein said second end of said conveyor linkage is rotatably attached to said conveying member for transmitting said horizontal differential motion from said conveyor linkage to said conveying member.

11. A conveyor, as claimed in claim 10, wherein a distance from said first axis to said second axis, in a plane substantially perpendicular to each of said first axis and said second axis, is approximately two times a distance from said first connection to said first axis, in a plane substantially perpendicular to said first axis and containing said first connection.

12. A conveyor, as claimed in claim 10, wherein said horizontal differential motion is described by the function:
ƒ(t)=2 sin(ω₁t)−sin(2ω₂t)
wherein:
t =time;
ω₁=an angular velocity of said first axis rotating about said second axis; and
ω₂=an angular velocity of said first connection rotating about said first axis.

13. A conveyor, as claimed in claim 10, wherein a dimension of a pitch radius of said ring gear is approximately equal to three times a dimension of a pitch radius of said pinion.

14. A conveyor, as claimed in claim 10, wherein said first connection does not fall on a line which is perpendicular to said first axis and said second axis at a start of a horizontal differential motion cycle.

15. A method of generating a horizontal differential motion, comprising the steps of:
rotating a first axis about a second axis in a first direction, wherein said first axis is generally parallel to said second axis;
rotating a first connection about said first axis in a second direction; and
transmitting said horizontal differential motion from said first connection.

16. A method of generating a horizontal differential motion, as claimed in claim 15, further comprising the step of positioning said first axis, said second axis, and said first connection wherein said horizontal differential motion is described by the function:
ƒ(t)=2 sin(ω₁t)−sin(2ω₂t)
wherein:
t=time;
ω₁=an angular velocity of said first axis rotating about said second axis; and
ω₂=an angular velocity of said first connection rotating about said first axis.

17. A method of generating a horizontal differential motion, as claimed in claim 15, further comprising a step of positioning said first axis, said second axis, and said first connection such that a distance from said first axis to said second axis is approximately two times a distance from said first axis to said first connection.

18. A method of generating a horizontal differential motion, as claimed in claim 15, further comprising a step of positioning said first axis, said second axis, and said first connection such that said first connection does not fall on a line which is perpendicular to said first axis and said second axis at a start of a horizontal differential motion cycle.
